(19) United States
(12) Patent Application Publication
(10) Pub. No.: US 2022/0307350 A1
(43) Pub. Date: Sep. 29, 2022

(54) VERTICAL BRANCH INLINE MANIFOLD SYSTEM

(71) Applicant: Vecto Gray Scandinavia AS, Nailsea (GB)

(72) Inventor: Steinar Lindemann HESTETUN, Hovik, Akershus (NO)

(21) Appl. No.: 17/597,178

(22) PCT Filed: Jun. 25, 2020
(86) PCT No.: PCT/EP2020/025302

§ 371 Date: Dec. 28, 2021

(30) Foreign Application Priority Data
Jul. 1, 2019 (NO) 20190828

(51) Int. Cl. E21B 43/017; E21B 43/013

(52) U.S. Cl. CPC E21B 43/017; E21B 43/013

(57) ABSTRACT

The present invention relates to a hydrocarbon production inline manifold system. The inline manifold system includes a carrier pipe with a longitudinal carrier pipe axis. The carrier pipe is provided with a plurality of hubs each with a jumper port. A hub longitudinal axis is arranged perpendicular to the carrier pipe axis. The hub longitudinal axes of the plurality of hubs are in a common plane with the carrier pipe axis. A flow line is located inside the carrier pipe. At least one valve is located in a flowpath between each of the plurality of hubs and the flow line.

The present invention relates to a vertical branch inline manifold system. In particular the invention relates to a vertical branch inline manifold system for installation on a pipeline conveying hydrocarbon fluids along the seabed. The invention is particularly adapted to allow tie-in connections to vertical connectors integrated in a pipeline. The inline manifold system of the invention allows replacement of external manifolds and is a simplified method for connecting multiple wells from a reservoir to a pipeline without the use of further manifold structures.

The inline manifold is intended for one or more branches, ending in a vertical connection and with a barrier valve.

The installation method for the vertical branch inline manifold system may be similar to inline-T installation, typically equipped with hinged mudmats, bend restrictors, support frame etc.

A typical seabed pipeline laying procedure includes implementing a pipe laying vessel where sections of pipeline are welded together on-board the vessel. The vessel moves at constant speed while welding stations are moving along the vessel at the same speed as the pipeline (typical s-lay method but can also be J-lay).

At present, the normal procedure is to lay down a pipeline at the seabed that is prepared for later connection of the various production equipment of the production field, such as manifolds, control systems, wellheads and Christmas trees etc. The various production equipment is separately lowered and thereafter connected to the pipeline.

However, there is a constant request in the marked for solutions enabling improved efficiency during layout of a production field. There is also a need for simplified field solutions that combine simplicity with flexibility.

Furthermore, if the seabed and soil of the oilfield contain sand or mud lowering the weight carrying capacity of the oilfield, it is an advantage to minimize the total weight of subsea equipment. It would be an advantage in such situations of one or more production structures could be integrated in the pipeline structure.

It is thus a purpose of the present invention to provide a manifold system integrated on a pipeline at an assembly stage that allows at least one branch to be installed while at the same time the inline manifold system is allowed to be installed and launched through the tensioner system and the stinger on the pipe lying vessel. Furthermore, it is a purpose of the present invention to provide a compact system that is simple to adapt to specific needs, that include few parts, that is easy to stock, that is standardized, and that has no flowline connections. The ability to be launched from a pipeline launch vessel and through a stinger makes the manifold system of the invention particularly suited for subsea use.

The term “vertical” it is meant to describe branches arranged mainly perpendicular to the pipeline axis. In preferred embodiments the branches will also be arranged perpendicular to the seabed or standing on the pipeline structure in a vertical position. The intention of arranging the branches perpendicular to one side of the pipeline is to obtain a slender structure for the overall manifold enabling passage through pipe laying equipment such as stingers on a pipeline laying vessel. The term “vertical” is thus chosen to simplify the description and should be used in this respect and to indicate the interrelation of the components and not the actual angle of installation.

The present invention relates to a hydrocarbon production inline manifold system comprising a carrier pipe with a longitudinal carrier pipe axis. “Hydrocarbon production” is intended to cover the different processes during hydrocarbon production and includes water injection into wells. The carrier pipe is provided with a plurality of hubs each with a jumper port and a hub longitudinal axis arranged perpendicular to the carrier pipe axis. The hub longitudinal axes of the plurality of hubs are in a common plane with the carrier pipe axis. A flowline is located inside the carrier pipe. At least one valve is located in a flowpath between each of the plurality of hubs and the flowline.

Each of the plurality of hubs may be fixed to a longitudinal alignment system attached to the carrier pipe.

The longitudinal alignment system may include a common carrier frame for the plurality of hubs. A plurality of frame spacers may extend between the common carrier frame and the carrier pipe. The at least one valve of each of the plurality of hubs may then be is located between the common carrier frame and the carrier pipe.

The longitudinal alignment system may include an individual carrier frame for each hub. A plurality of frame spacers may then extend between each of the carrier frames and the carrier pipe, and the at least one valve of each of the plurality of hubs is then located between each of the carrier frames and the carrier pipe.

Hinged mudmat elements may be arranged on each side of the carrier pipe and the alignment system.

A locking arrangement may lock the mudmats in an unfolded position upon transition of the mudmats from a folded position to the unfolded position.

A bend restrictor may be fixed to each end of the carrier pipe and the flowline may run through the bend restrictor.

A plane of the hinged mudmat elements in an unfolded position may be perpendicular each of the longitudinal axes of the plurality of hubs.

The carrier pipe may include openings, and a connecting pipe forming a T-branch with the flowline may extend through each of the openings in the carrier pipe and may be in fluid connection with each of the valves.

Short description of the enclosed drawings:

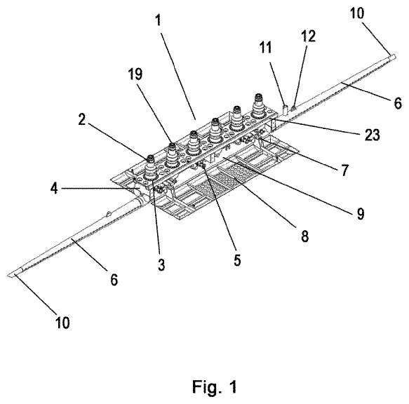

FIG. 1 is a perspective view of a vertical branch inline manifold system of the invention;

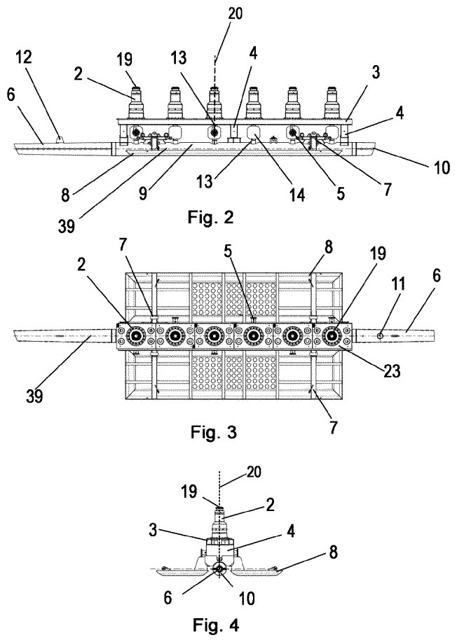

FIG. 2 is a side elevation of the vertical branch inline manifold system shown in FIG. 1, in an unfolded operating configuration;

FIG. 3 a top view of the vertical branch inline manifold system shown in FIG. 1-2, in an unfolded operating configuration.

FIG. 4 a front view of the vertical branch inline manifold system shown in FIG. 1-3, in an unfolded operating configuration;

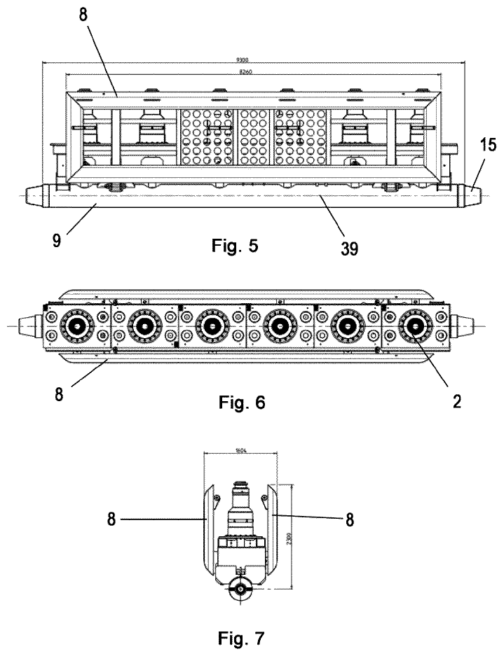

FIG. 5 is a side elevation of the vertical branch inline manifold system shown in FIG. 1-4, in a folded installation configuration;

FIG. 6 a top view of the vertical branch inline manifold system shown in FIG. 1-5, in an unfolded installation configuration.

FIG. 7 a front view of the vertical branch inline manifold system shown in FIG. 1-6, in an unfolded installation configuration;

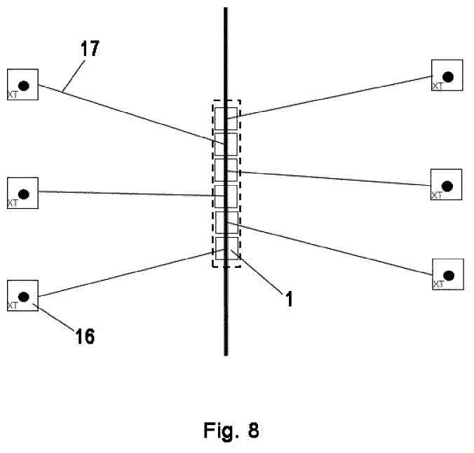

FIG. 8 is a schematic representation of the vertical branch inline manifold system connected to wellheads through jumpers; and

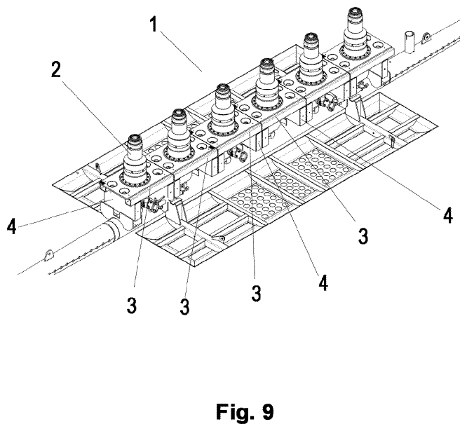

FIG. 9 is a perspective view of a vertical branch inline manifold system of an alternative embodiment of the invention.

Detailed description of an embodiment of the invention with reference to the enclosed drawings:

FIGS. 1-7 show an inline vertical manifold 1 comprising a set of manifold hubs 2 connected to a carrier pipe 9 installed in a flowline 10. Each hub 2 is supported by a hub carrier frame 3. The shown embodiment of an inline vertical manifold 1 is a six slot manifold with vertical inline branches installed in a carrier frame comprising a set of hub carrier frames 3 and frame spacers 4 holding the structure. A bend restrictor 6 is fixed to each end of the carrier pipe 9 and is arranged around the flowline 10 from the end sections to a distance away from the inline manifold.

The inline vertical manifold 1 is provided with a hinged mudmat 8. FIGS. 5-7 show the inline manifold 1 with the mudmat in a folded position typically used during transport and during the process of lowering the inline manifold from a vessel to the seabed. The mudmat elements are tied to each other by means of one or more wires.

FIGS. 2-4 show the inline manifold 1 with the mudmat unfolded. To unfold the mudmat 1, the one or more wires holding the mudmat elements are cut, thereby allowing the mudmat elements to unfold and fall to the seabed. The mudmat elements are provided with a lock system to hold the mudmat in the unfolded position. The lock system can include spring loaded bolts that are pressed into a locking position when the mudmat is unfolded. Manually operated locks may alternatively lock the mudmat in the unfolded position. Telescopic arms or locking bolts may also be used. Such telescopic arms or locking bolts may be spring loaded towards a locked position.

In FIG. 1, the mudmat 8 is in a deployed configuration where the at least two mudmat parts are unfolded and each carrier surface define a single mudmat plane. This unfolded operating position maintains the vertical branch inline manifold system stability while locating the inline manifold at a predictable position in relation to the seabed. Two spring loaded locking arrangements 7 hold the mudmat in a folded or unfolded position.

A jumper port 19 on each of six vertical inline branches can be closed with a valve with a torque tool bucket 5 allowing a ROV to open or close the valve. Alternatively, the torque tool bucket 5 could be substituted with an integrated, powered actuator.

Each vertical inline branch includes a vertical hub and alignment system. The hub 2 includes a flowline bore from the jumper port 19 to the flow line, a carrier frame 3 and a valve.

The hinged mudmat 8 is secured to a carrier pipe 9 through a flowline bend restrictor 6 at each side interconnected by the carrier pipe 9. The flowline bend restrictors 6 are inline with the carrier pipe 9 while the flowline 10 is entered inside the bend restrictors 6 leading to the inline manifold 1. Six connecting sleeves connect the hubs 2 to the flowline 10 with respective valves through openings in the carrier pipe 9 and further to the flowline 10.

The carrier pipe 9 accommodates the loads in the flowline 10, and the bend restrictors 6 distribute the loads on the flowline 10 and prevent stress concentrations and buckling.

Temporary mudmat locking pins and/or secure wires (not shown) may be provided to hold the two, hinged mudmat halves of the mudmat 8 in a folded position prior to installation on a seabed. A pressure or protection cap (not shown) six in total may be located on each hub 2 to provide pressure barrier or debris/impact protection.

A transponder bucket 11 is installed allowing position measurement during and after installation, as well as metrology. An ROV may remove the instrument after final measurement.

The flows from the jumper ports 19 are channelled through each vertical inline branch at the centre of the inline manifold 1 to the carrier pipe 9 and further to the flowline 10.

Each bend restrictor 6 includes a padeye 12.

A longitudinal alignment system 23 including hub carrier frames 3 is supported at a distance from the carrier pipe 9 by frame spacers 4 at each end and at the middle. The frame spacers 4 are dimensioned to allow barrier valves to be installed between the longitudinal alignment system 23 and the carrier pipe 9.

Two spring loaded locking arrangements 7 hold the mudmats 8 in the unfolded position. The jumper ports 19 connect a jumper with the flowline 10. Padeyes 12 facilitate lifting.

The FIGS. 2-7 illustrates the invention of FIG. 1 in detail. In FIG. 2 the valves 14 are faced such that a valve is facing in an opposite direction in relation to the flowline 10 exit direction to provide better space between each hub 2. The valves 14 are connected to the flow line with connecting sleeves or connecting pipes 13 extending through the carrier pipe 9 and into flowline 10. The valves 14 may be of a kind providing a double barrier, and “the valve” is not intended to exclude two valves to accommodate a double barrier requirement.

The longitudinal hub block frame 3 supported at a distance from the carrier pipe 9 includes a straight frame portion extending along the length of the system to allow the number of hubs 2 to be lined up and secured to the frame. The frame spacers 4 are arranged at each end and at the middle of the longitudinal hub block frame 3. The frame spacers 4 dimensioned to allow the barrier valves 14 to be installed between the longitudinal hub block frame 3 and the carrier pipe 9, extending perpendicularly to a longitudinal axis 39 of the carrier pipe 9 and a longitudinal axis of the longitudinal hub block frame 3. The a longitudinal axis 39 of the carrier pipe 9 is perpendicular to a hub longitudinal axis 20.

FIG. 3 shows the invention from above with the mudmat 8 in the unfolded position. Flow through each of the six hubs 2 is controlled by actuating the respective torque tool buckets 5 in connection with respective barrier valves. The two spring loaded locking arrangements 7 are in a locked position holding the mudmat 8 in the unfolded position. The transponder bucket 11 is attached to one of the bend restrictors 6. The jumper ports 19 are facing upwards. The longitudinal alignment system 23 is shown from above and includes the longitudinal hub block frame.

FIG. 4 is a front elevation of the system shown in FIGS. 1-3 and highlights the position of the flowline 10 at the centre of the bend restrictor 6 directly below the hub 2 held in place by the longitudinal hub block frame 3 secured to the carrier pipe by the frame spacers 4. Fluid is allowed to flow through the jumper port 19 and into the flowline 10 when a barrier valve is open. The two mudmat parts forming the mudmat 8 are located in one single plane that is perpendicular to the hub longitudinal axis 20.

The hubs 2 are directed perpendicularly to the flowline 10, the carrier pipe 9 and to the unfolded mudmat 8 and are thus facing directly upwards when the system is installed when the inline manifold 1 is positioned at the seabed, it will provide a vertical jumper connection.

FIG. 5-7 shows the system of FIGS. 1-4 with the two mudmat parts of the mudmat 8 in a folded position, from the side, from the front, and from above respectively. The folded position is typically used during installation of the system before the system reaches a seabed. A bend restrictor and carrier pipe coupling 15 is located at each side of the carrier pipe 9 holding the flow line. The bend restrictor and carrier pipe coupling 15 centralizes the flowline inside the carrier pipe to prevent physical contact between the two. The longitudinal axis of the carrier pipe 9 is accordingly coinciding with the longitudinal axis of the flowline.

In the installation configuration the at least two mudmat parts are folded and each carrier surface define separate carrier planes.

The folded position is maintained to allow assembly of the inline manifolds and the mudmats 8 onto the flowline on a pipe laying ship during pipe laying operations. The width of the assembly is less than a maximum width the pipe laying ship allows. The assembly may be installed on the flowline during ordinary pipe laying operation without stopping the pipe laying ship. The bend restrictor 6 and the carrier pipe 9 also facilitates the assembly on the flowline assembly line.

The hubs 2 are facing towards the top of the system and is located between the folded mudmat parts.

Six clamp connectors (not shown) are located on the hubs to provide suitable connections with branch pipes/jumpers.

Telescopic arms (not shown) may extend above the two mudmat parts and secure the mudmat in the open, unfolded position. The telescopic arms may run in a direction parallel to the mudmat parts when these are unfolded and may also contribute to the unfolding of the two mudmat parts in the event the mud mat parts do not unfold completely under the effect of gravity.

FIG. 8 shows a configuration of the inline manifold system 1, with the jumpers 17 entering the hubs vertically from two opposite sides into the flow line. A plurality of hubs may be installed inline without any practical limit in the number of hubs. The distance between each hub is only limited by the size of the clamp connectors, and the allowable length of each section on the pipe laying ship. This results in a compact and flexible manifold configuration. The jumpers 17 connects the inline manifold system 1 to wellheads 16.

The embodiment on FIG. 9 corresponds to the embodiment of other figures apart from showing an in-line manifold 1 where each hub 2 is fixed to the carrier pipe 9 with a hub block frame 3 and two frame spacers 4 extending between the hub block frame 3 and the carrier pipe 9. This embodiment offers great flexibility in terms of the number of hubs 2 on the manifold.

1-9. (canceled)

10. A hydrocarbon production inline manifold system comprising a carrier pipe with a longitudinal carrier pipe axis, wherein
the carrier pipe is provided with a plurality of hubs each with a jumper port;
a hub longitudinal axis is arranged perpendicular to the longitudinal carrier pipe axis;
the hub longitudinal axes of the plurality of hubs are in a common plane with the carrier pipe axis;
a flowline (10) is located inside the carrier pipe; and
at least one valve is located in a flowpath between each of the plurality of hubs and the flowline.

11. The inline manifold system according to claim 10, wherein each of the plurality of hubs is fixed to a longitudinal alignment system attached to the carrier pipe.

12. The inline manifold system according to claim 11, wherein the longitudinal alignment system includes a common carrier frame for the plurality of hubs, wherein a plurality of frame spacers extend between the common carrier frame and the carrier pipe, and wherein the at least one valve of each of the plurality of hubs is located between the common carrier frame and the carrier pipe.

13. The inline manifold system according to claim 11, wherein longitudinal alignment system includes an individual carrier frame for each hub, wherein a plurality of frame spacers extend between each of the carrier frames and the carrier pipe, and wherein the at least one valve of each of the plurality of hubs is located between each of the carrier frames and the carrier pipe.

14. The inline manifold system (1) according to claim 10, wherein hinged mudmat elements are arranged on each side of the carrier pipe and the alignment system.

15. The inline manifold system according to claim 14, further including a locking arrangement locking the mudmats in an unfolded position upon transition of the mudmats from a folded position to the unfolded position.

16. The inline manifold system according to claim 10, wherein a bend restrictor is fixed to each end of the carrier pipe, and wherein the flowline runs through the bend restrictor.

17. The inline manifold system according to claim 14, wherein a plane of the hinged mudmat elements in an unfolded position is perpendicular each of the longitudinal axes of the plurality of hubs.

18. The inline manifold system according to claim 14, wherein the carrier pipe includes openings, and wherein a connecting pipe forming a T-branch with the flowline extending through each of the openings in the carrier pipe is in fluid connection with each of the valves.
